(19) United States
(12) Patent Application Publication
(10) Pub. No.: US 2003/0108848 A1
(43) Pub. Date: Jun. 12, 2003

(54) Plan to develop intellectual property

(76) Inventor: Martha Anne Cohen, Cincinnati, OH (US)

Correspondence Address: Martha A. Cohen, Ph.D., 9395 Plainfield Rd., #5, Cincinnati, OH, 45236, US

(21) Appl. No.: 10/005,500

(22) Filed: Dec. 7, 2001

(51) Int. Cl. G09B 19/00

(52) U.S. Cl. 434/118

(57) ABSTRACT

The nature of the technical disclosures of the invention, herein, is a plan to access needed resources and build a base upon which to complete the development of intellectual property. The user has a choice between adjuncting the Plan to a current profession and lifestyle or integrating a whole lifestyle into the Plan to have a profession associated with the Intellectician^{SM} Service Mark and optionally a secondary, individualized Service Mark. The individual contracts to credit or license back certain creative property(s) as a gift to the resource institution, and the integrity of the property development is fostered by an allied feed back provision.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Not Applicable

### BRIEF SUMMARY OF THE INVENTION

Not Applicable

### BRIEF DESCRIPTION OF THE SEVERAL VIEWS OF THE DRAWING

Not Applicable

### DETAILED DESCRIPTION OF THE INVENTION

The plan is a means to enable an individual's development of intellectual property outside of existing patented propriety. Wherever one lives, the invention is a means to access needed resources and build a base upon which to complete the development of the intellectual property.

Where Institution of Higher Education library-use is accessed for developing intellectual property within or as a profession outside of the Institution's business/finding/programs, the enterprise parallel does not compete tortiously because the plan is outside of their existing extramural or endowed programs.

The Plan has two parts. The first part of the plan is not specific to any Service Mark. The problems that arise within the development, feed back into the plan, and benefit the resource and facilitate the completion of the next finished product while providing for greater assimilation within whatever the individual's construct for happiness is under civil law.

The Institution of Higher Education membership is cultivated through a mechanism that does not restrict or limit the expertise of or insult the lifestyle of the Intellectual Property Professional who may or may not be establishing rights to the Service Mark, to be an Intellectician^{SM}, as is specified in Part II. This is accomplished through a thorough examination of the Institution's Bylaws/Rules or the equivalent in combination with any relevant laws.

The First Part of the Plan (Part I).

A contract is written that promises to purchase a membership in a local Institution of Higher Education's Donor Foundation or other suitable office using whatever boundaries have been printed within the Institution's Rules or Bylaws pursuant to law. It includes a full library purchase with a tailored promise.

In exchange for payment rendered by the individual for use of full on and off-site library privileges, using the purchase of a Foundation Membership or other suitable office, or other suitable office, the individual contracts to credit via a scholarly byline/address or licenses back certain of the property with a guarantee to donate, as a gift, all or a portion of the results of the sufficiency of the resources for the work at hand and the solution used to develop and finish the product (intellectual property) outside of that Institution's library (unless classified by an entity or sealed by a court of law).

Implicit within the finished product is the knowledge of that which went-wrong, which under the plan is recorded on paper making it suitable for official publication potentially for submission to an entity so that the privacy sufficiency of the library's performance for the finished product (to have the desired integrity) is addressed for the public. For instance, having to tell library office workers not to exploit, among themselves, or outside their job, the titles of the materials used in the property development, and any other encumbrances to the job of the property development.

Where the place of residence is insufficient for completion of the finished product or the maintenance of its integrity, another contract is invoked elsewhere but entered into with a different Institution is library. The terms there also include a donation back for such a contract to be This plan enables knowledge acquisition of how to split access between multiple resources in order to fully develop the property.

The second part of the plan (Plan II)¹ is specific to a licensee seeking to be an Intellectician^{SM} by profession and possibly establishing their own secondary modal Service Mark (i.e., apply for one through the Federal Government). ¹The aim here includes an alternative to the Postdoc practice wherein one has a job, per se, that is, if the Individual so desires to follow the entire Plan, but does not expect to become excluded from candidacy for an academic position at a later point in time where the developed property is sophisticated enough.

The mechanism includes the Elements, i.e., defined assimilation choice(s), and (1) how the asset base is built, and (2) in what form the developers reputation is built. All of this occurs within the individual's needs for their intellect within the boundaries of civil law.

This keeps an entity mandate or mission or a lack of same from interfering with one's own civil creativity but enables the use of that legacy (i.e., the entity's) through paid privileges where the entity agrees to them. All, within an intent to donate or license back certain portions learned in the process or creatively developed by the Plan-user's intellect.

The mechanism underlying the second part (Part II) is consistent with the constitutional right to happiness. The Elements are assimilation choices that are individualized. Whatever portion of society that is serviced, then, values the creativity (intellectual property)—and the patent where choices have been individualized.

A. This individualization is mechanistic for:

1. building the asset base to work from (for, d.b.a.)

2. establishing and obviousing the form in which the asset holder's reputation is built,

3. ensuring that the individuality satisfies the asset holder's intellectual need while remaining within the boundaries of civil law.

B. The individualization extends as needed within the following.

From the individual to d.b.a. (doing business as)

| assets relevant | leading to | asset base |
|---|---|---|
| 1. Educational degree earned | leading to | Purpose for |
| and/or relevant talent | | accomplishing the |
| | | property. |
| 2. Location of residence | leading to | One or more contracts |
| | | under the Plan. |
| 3. (a) Assimilation choices | leading to | The interactions |
| | | between centers and |
| | | dispersers and users of |
| | | knowledge (where the |
| | | individuaPs |
| | | professional Service |
| | | Marks are |
| | | commensurate). |
| 3. (b) Cultivated intellectual property | leading to | same as 3 (a), this |
| | | column. |
| 4. Reputation | leading to | Tangible proof of |
| | | reputation for the |
| | | Purpose. |

What I claim as my invention is:

1. A plan to develop intellectual property.

2. A means to access needed resources without demeaning one's lifestyle.

3. A means to accomplish claim #2 without instilling competition at one or more institutions of higher education which also produce intellectual property.

4. A feedback facility to benefit the plan further.

5. A means to accomplish claim #1 without limiting assimilation choices to a fixed contractual arrangement.

6. A plan to tailor a promise.

7. A plan for the finished product to have the desired integrity.

8. A plan to enable knowledge acquisition of divulging.

9. A plan to circumvent location of residence and have domestic sophistication for the development in claim #1.

10. A plan to use the domestic access to cultivate the knowledge that the individual needs to build the global plan for same (claim #1).

11. A plan to enable an individual to augment their current professional practice and/or lifestyle with a new plan to develop intellectual property.

12. A plan that has two parts, and the second part is optional.
